(19) United States
(12) Patent Application Publication
(10) Pub. No.: US 2020/0248971 A1
(43) Pub. Date: Aug. 6, 2020

(54) HIGH TEMPERATURE THERMOCHEMICAL ENERGY STORAGE SYSTEM

(71) Applicant: Southern Research Institute, Birmingham, AL (US)

(72) Inventor: Andrew Jerome Muto, Cary, NC (US)

(21) Appl. No.: 16/648,094

(22) PCT Filed: Sep. 24, 2018
(86) PCT No.: PCT/US2018/052390

§ 371 Date: Mar. 17, 2020

Related U.S. Application Data
(60) Provisional application No. 62/649,406, filed on Mar. 28, 2018.
(60) Provisional application No. 62/562,768, filed on Sep. 25, 2017.

(51) Int. Cl. F28D 20/00; C09K 5/16

(52) U.S. Cl. CPC F28D 20/003; C09K 5/16

(57) ABSTRACT

A thermochemical energy storage system and method of storing thermal energy are disclosed. The energy storing system described herein comprises a reactor comprising a CO₂ sorbent comprising MgO, and b) a supercritical CO₂ source, wherein the supercritical CO₂ source is in fluid communication with the reactor and the CO₂ sorbent comprising MgO to allow flow of supercritical CO₂ between the supercritical CO₂ source and the reactor, thereby allowing contact of CO₂ with the CO₂ sorbent comprising MgO.

### CROSS-REFERENCE TO RELATED APPLICATIONS

This application claims the benefit of U.S. Provisional Application Nos. 62/562,768, filed Sep. 25, 2017, and 62/649,406, filed Mar. 28, 2018, which are both incorporated herein by reference in their entirety.

### BACKGROUND

Societal energy demands are constantly increasing while fossil fuel resources, the main energy resource of many national energy systems, are limited and predicted to become scarcer, and as a result to become more expensive in coming years. Furthermore, many concerns exist regarding the environmental impacts associated with continuous drilling and pumping of the fossil fuels from the Earth's crust and increasing energy consumption. Specifically, concerns have been raised regarding the possible effect of increased use of fossil fuels on climate change and atmospheric pollution.

Changes are required in energy systems, partly through the adoption of advanced energy technologies and systems to address these serious environmental concerns. The anticipated worldwide increase in energy demand and concern regarding environmental problems has become a driving force for the utilization of more efficient and cleaner energy technologies. Examples include advanced systems for waste energy recovery and energy integration. Important technologies that can contribute to avoiding environmental problems and increasing the efficiency of energy consumption include thermal energy storage (TES), and more specifically, thermochemical energy storage (TCES).

Thermal energy storage is especially an important technology in systems involving renewable energy sources as well as other energy resources as it can make their operation more efficient. One example is bridging the periods between when energy is harvested and when it is needed. For example, the next generation of advanced concentrating solar power (CSP) plants are being designed to increase the sunlight to electricity conversion efficiency, and one of the major techniques to enact this increase is through the use of receivers, heat transfer fluids (HTF), thermal energy storage systems, and power blocks that operate at high temperatures. It was found that CSP systems, for example, require thermal energy storage to be competitive with conventional grid scale power generation systems. Thus, TES can play an important role in increasing the contribution of various types of renewable energy in the energy production of regions and countries.

Various TES technologies and applications exist. The selection of a TES system for a particular application depends on many factors, including storage duration, economics, supply and utilization temperature requirements, storage capacity, heat loss and available space.

More compact TES can be achieved based on a system that utilize chemical reactions. However, the current-state-of the-art molten salt based thermal storage systems are unable to operate in the high temperature range required, for example, in CSP systems. High temperature thermal energy is generally stored as sensible heat in either molten salt or synthetic organic heat transfer oil. However, these mediums store heat in a very low volumetric energy density and are not able to store heat above 500° C.

Therefore, thermochemical energy storage systems exhibiting very high volumetric energy density and capable of operating through a wide temperature range are needed. Even further, improved methods for storing energy would be desirable.

Accordingly, such thermochemical energy storage systems and methods for storing energy are described herein.

### SUMMARY OF THE INVENTION

Disclosed herein is a system for storing energy comprising: a) a reactor comprising a CO₂ sorbent comprising MgO; and b) a supercritical CO₂ source, wherein the supercritical CO₂ source is in fluid communication with the reactor and the CO₂ sorbent comprising MgO to allow flow of supercritical CO₂ between the supercritical CO₂ source and the reactor, thereby allowing contact of CO₂ with the CO₂ sorbent comprising MgO.

Also disclosed herein is a method of storing energy comprising the steps of: a) in a reactor, heating and/or subjecting electrical energy to MgCO₃ or a salt of MgCO₃ with supercritical CO₂ having a temperature of at least 450° C., thereby promoting an endothermic chemical reaction to produce CO₂ and MgO; and b) separating the CO₂ from the MgO. As disclosed herein the reactor comprises a CO₂ sorbent comprising MgO.

Also discloses herein is a containment vessel configured to be placed underground and withstand high pressure comprising: a) a metal housing configured to sustain temperatures of at least 300° C. at a pressure of at least 200 atm during use; i. wherein the metal housing is at least partially surrounded by an inflatable liner configured to be inflated and to be filled with a filler; and ii. wherein the housing comprises an opening configured to transfer material to and from the metal housing.

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive of the invention, as claimed.

### DESCRIPTION OF THE FIGURES

The accompanying figures, which are incorporated in and constitute a part of this specification, illustrate several aspects, and together with the description, serve to explain the principles of the invention.

FIG. 1 shows a process flow diagram of a TCES system described herein.

FIG. 2 show an exemplary design of a reactor disclosed herein, such as a heat exchange reactor.

FIG. 3 shows an isothermal cycle of a method disclosed herein.

FIG. 4 shows a gas-solid reaction equilibrium of MgO/MgCO₃.

FIG. 5 shows the exergy of a system disclosed herein with all irreversibles or reactor irreversibles only.

FIG. 6 shows a plot of the equilibrium CO₂ partial pressure vs. temperature for MgCO₃ within a supercritical CO₂ power cycle.

FIG. 7 shows the itemized cost versus energy storage density of the material. Assuming a d=16 [m] shaft diameter.

FIG. 8 shows the behavior of a MgO sorbent over 150 cycles.

### DETAILED DESCRIPTION

The present invention can be understood more readily by reference to the following detailed description of the invention.

Disclosed herein are systems, materials, compounds, compositions, and components that can be used for, can be used in conjunction with, can be used in preparation for, or are products of the disclosed method and compositions. It is to be understood that when combinations, subsets, interactions, groups, etc. of these materials are disclosed that while specific reference of each various individual and collective combinations and permutation of these compounds cannot be explicitly disclosed, each is specifically contemplated and described herein. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

All publications mentioned herein are incorporated herein by reference to disclose and describe the methods and/or materials in connection with which the publications are cited.

### 1. Definitions

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a system” includes combination of two or more such systems, and the like.

“Optional” or “optionally” means that the subsequently described event or circumstance can or cannot occur, and that the description includes instances where the event or circumstance occurs and instances where it does not.

“Consists essentially of” limits the scope to the specified materials (i.e. MgO) or steps and those that do not materially affect the basic and novel characteristic(s) of the claimed invention.

“Consisting of” limits the scope to the specified materials (i.e. MgO).

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The term “thermal energy storage” as defined herein is referenced to a system capable of temporary holding thermal energy in substances for later utilization.

The term “sensible thermal energy storage” as defined herein is referenced to energy stored in vibrational modes of molecules. Sensible TES systems store energy by changing the temperature of the storage medium, which can be water, brine, rock, soil, concrete, sand, molten salt and the like.

The term “latent thermal energy storage” as defined herein is referenced to energy stored in medium as it changes phase, for example cold storage water/ice and heat storage by melting paraffin waxes.

The term “thermochemical energy storage” is referred to energy stored in chemical bonds of molecules, or in the reaction between the reactants. For example, metal oxides, reversible reduction oxidation reactions, and the like. Thermochemical energy storage can also include a system that allows separation of reactants that can be subsequently combined again in exothermic reaction. For example, the separation and later re-combination of CO₂ and MgO.

The term “sorbent” as used herein is referred to a solid material capable of absorbing \ liquids or gases via fluid-solid chemical reaction

The term “heat exchange reactor” as used herein is referred to a reactor used to transfer heat between one or more fluids. The fluids can be separated by a solid wall to prevent mixing or they can be in direct contact.

The term “adiabatic reactor” as used herein is referred to a reactor that utilizes an adiabatic process that occurs without loss of heat, or matter, between the reactor and its surroundings.

The terms “gas expander” or “turboexpander,” or “expansion turbine” or “turbine” can be used interchangeably and are referred to a centrifugal or axial flow turbine through which a high pressure gas is expanded to produce work.

The term “exothermic reaction” as referred herein is a chemical reaction that releases energy by heat.

The term “endothermic reaction” as referred herein is a reaction in which the system absorbs energy from its surroundings. In some aspects, the absorbed energy is in the form of heat.

The term “temperature swing” as referred herein is a process to control a temperature of the system by setting the temperature spread between the heat or cool on and off temperatures. Swing is determined by the temperature difference between where a system comes on and then goes off.

The term “pressure swing” as referred herein is a process to control products by changing the pressure in the system. In certain exemplary aspects, the pressure swing can be used to lower CO₂ pressure and thus decompose MgCO₃.

A supercritical fluid as described herein is a fluid at a temperature above its critical temperature and at a pressure above its critical pressure. A supercritical fluid exists at or above its “critical point,” the point of highest temperature and pressure at which the liquid and vapor (gas) phases can exist in equilibrium with one another. Above critical pressure and critical temperature, the distinction between liquid and gas phases disappears. A supercritical fluid possesses approximately the penetration properties of a gas simultaneously with the solvent properties of a liquid. Accordingly, supercritical fluid extraction has the benefit of high penetrability and good solvation.

As used herein, a fluid which is “supercritical” (e.g. supercritical CO₂) indicates a fluid which would be supercritical if present in pure form under a given set of temperature and pressure conditions.

A weight percent of a component, unless specifically stated to the contrary, is based on the total weight of the formulation or composition in which the component is included.

Disclosed are compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and agents are disclosed and discussed, each and every combination and permutation of the polymer and agent are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

### 2. System

Discloses herein is a high pressure/temperature, low-cost, underground reactor technology: a containment vessel for large scales at a remarkably lower cost curve than conventional pressure vessels. The disclosed containment vessel can be protected from harsh weather and unforeseen human events on the surface; small footprint on the surface which is amenable to retrofitting existing plants. The containment vessel enables economical use of high pressure thermochemical reactions (ammonia and methanol synthesis) for increased efficiency (less pumping power) and higher selectivity (high driving forces and extent of reaction.

Unlike conventional systems, supercritical CO₂ thermochemical energy storage provides valuable “cold storage” as well as “hot storage” which is accomplished efficiently at a modest incremental cost. In addition reactants and products can even be transported long distances unlike conventional systems to link heat supply with demand.

Supercritical CO₂ grid synergies uses supercritical CO₂ as the reaction gas and heat transfer fluid and enables low-cost, high efficiency integration with systems that use supercritical CO₂ as a working fluid, such as power cycles and refrigeration cycles. The disclosed supercritical CO₂ thermochemical energy storage can be a component in the larger CO₂ smart grid, sharing synergies with other applications, such as CO₂ pipelines for enhanced oil recovery, and carbon capture usage and storage.

Disclosed herein is a system that can allow affordable and efficient storage of energy. It is desirable to obtain a thermal energy storage system having a high cyclic durability, high volumetric energy density, capable of operating throughout a wide temperature range, while still providing economic feasibility. An advantage of thermochemical energy storage systems over other energy storage systems is the small temperature range (ΔT) over which the charge and discharge cycle occurs, typically around 25-50° C. This small temperature range allows for high exergetic round-trip efficiency, and has the potential to couple well with power cycles that approximate the Carnot ideal of heat transfer at constant temperature. The system disclosed herein utilizes a reversible gas-solid reaction, wherein the claimed reaction has substantially no potential side reaction, and the reactants and/or products are non-toxic and non-corrosive. The energy storage described herein uses highly reversible and highly energetic gas-solid reaction to store energy on a thermochemical basis.

Accordingly, disclosed herein is a system for storing energy comprising: a) a reactor comprising a CO₂ sorbent comprising MgO; and b) a supercritical CO₂ source, wherein the supercritical CO₂ source is in fluid communication with the reactor and the CO₂ sorbent comprising MgO to allow flow of supercritical CO₂ between the supercritical CO₂ source and the reactor, thereby allowing contact of CO₂ with the CO₂ sorbent comprising MgO. The supercritical CO₂ source can comprise any source known in the art. In some aspects, for example and without limitation the supercritical CO₂ source can comprise a commercially available CO₂ provided in a storage tank, which can be in a supercritical state within the supercritical CO₂ source, such as for example at about 74 atm at about 31° C.

In one aspect, the supercritical CO₂ source can be located at least partially underground. In another aspect, the supercritical CO₂ source can be located fully underground.

In one aspect, the supercritical CO₂ source can be the containment vessel configured to be placed underground and withstand high pressure disclosed herein.

Also discloses herein is a containment vessel configured to be placed underground and withstand high pressure comprising: a) a metal housing configured to sustain temperatures of at least 300° C. at a pressure of at least 200 atm during use; i. wherein the metal housing is at least partially surrounded by an inflatable liner configured to be inflated and to be filled with a filler; and ii. wherein the housing comprises an opening configured to transfer material to and from the metal housing.

In one aspect, the metal housing is configured to sustain temperatures of at least 500° C. at a pressure of at least 200 atm during use; For example, the metal housing can be configured to sustain temperatures of at least 700° C. at a pressure of at least 200 atm during use. In another example, the metal housing can be configured to sustain temperatures from about 300° C. to about 1,000° C. at a pressure of at least 200 atm during use.

In one aspect, the metal housing is configured to sustain temperatures of at least 500° C. at a pressure of at least 300 atm during use; For example, the metal housing can be configured to sustain temperatures of at least 700° C. at a pressure of at least 400 atm during use. In still further aspects, the metal housing can be configured to sustain temperatures of at least 750° C. at a pressure of at least 500 atm during use. In another example, the metal housing can be configured to sustain temperatures from about 300° C. to about 1,000° C. at a pressure from about 200 atm to about 500 atm during use.

The liner is narrow enough in the deflated state to be inserted in the axis of the whole metal housing. The liner is then inflated with pressure and back filled with a filler, such as high pressure grout. The liner is thin so that it does not contain any substantial pressure, but rather is just used for gas permeability. Once the filler, i.e. grout, is set then the containment vessel is ready to be loaded. In one aspect, the liner can be gas permeable.

In one aspect, a filler is present between the liner and the metal housing. The filler supports the metal housing and assists to withstand the pressure of the metal housing during use. The filler can comprise grout, fiber reinforced grout, or rock bolts. In one aspect, the filler comprises grout.

In one aspect, the containment vessel can be located at least partially underground. In another aspect, the containment vessel can be located fully underground.

In one aspect, the containment vessel is at least partially surrounded by bedrock. The bedrock supports the metal housing and assists to withstand the pressure of the metal housing during use. The bedrock also slows down heat transfer from the metal housing, which is desired.

The opening of the housing configured to transfer material, such as reactants, products, or supercritical CO₂ to and from the metal housing. The opening can have narrow restriction at the top of the bedrock surrounding the metal housing to hold the stress and reduce costs of the pressure cap. The metal housing can be used in any location, however it will affect cost on the depth and strength of the existing bedrock and the cost to excavate, construct the containment vessel, and reinforce the ground.

In one aspect, the metal housing has a diameter from about 4 meters to about 15 meters. In another aspect, the metal housing has a height from about 10 meters to about 100 meters. For example, the metal housing can be substantially cylindrical in shape.

The containment vessel is suitable for high pressure functionalities such as thermochemical energy storage, gas separation, and certain chemical synthesis.

In one aspect, the CO₂ sorbent consists essentially of MgO. In another aspect, the CO₂ sorbent consists of MgO.

In one aspect, CO₂ sorbent can comprise double salts, such as NaMg, which produces a salt of MgCO₃, such as Na₂MgCO₃.

In one aspect, the system disclosed herein can be charged with high-grade heat carried by supercritical CO₂ heat transfer fluid at 585° C. to less than 710° C., and 70-500 atm respectively, which drives the decomposition of MgCO₃ within the reactor. In yet other aspects, the system disclosed herein can be charged with high-grade heat carried by supercritical CO₂ heat transfer fluid at 585° C.-650° C., and 70-300 atm respectively, which drives the decomposition of MgCO₃ within the reactor. Evolved CO₂ reaction gas is cooled by flowing through a rock bed where sensible heat is stored for the return trip during discharge. The rock bed surrounds the hot reactor and functions as thermal insulation. CO₂ is stored near the critical point (31° C., 72 atm) where the liquid is dense and storage is cost-effective. For maximum power the system is discharged at maximum pressure/temperature (300 atm/675° C. or 500 atm/710), which corresponds to a thermal conversion efficiency of 50%. If refrigeration is desired sCO₂ is expanded to discharge conditions of 20 atm/−19° C. and also produces high grade heat in the reactor for the power cycle at 520° C. which could then run a CO₂ refrigeration cycle directly with shaft power. The supercritical CO₂ storage vessel has integrated functions as a condenser and evaporator. A round-trip exergy efficiency of 96% is expected for an isothermal reactor process.

It is further understood that in some aspects, the CO₂ sorbent can operate at temperatures greater than about 450° C., greater than about 500° C., greater than about 550° C., greater than about 600° C., greater than about 650° C., greater than about 700° C., greater than about 750° C., greater than about 800° C., or greater than about 850° C. In yet other aspects, the CO₂ sorbents can operate in a temperature range from about 450° C. to about 900° C., including exemplary values of about 450° C., about 500° C., about 550° C., about 600° C., about 650° C., about 700° C., about 750° C., about 800° C., about 850° C., and about 900° C. In yet other aspects, the CO₂ sorbents can operate in any temperature range between any two of the above stated values. For example, the CO₂ sorbents can operate from about 450° C. to about 800° C., about 650° C. to about 850° C., or from about 700° C. to about 900° C.

In some aspects, a highly reversible gas-solid carbonation-decarbonation reaction cycle using CO₂ sorbent can be employed. In some aspects, a high temperature carbonation-decarbonation cycle can be based on the reaction shown in Scheme 1:

Cycle 1: MgO+CO₂↔MgCO₃+108 KJ (Scheme 1)

It is understood that the described cycle is based on the reversible reactions of carbon dioxide with solid magnesium oxide. The magnesium oxide carbonates to form solid magnesium carbonate. In certain aspects, the sorbents described herein can undergo, without degradation, repeated endothermic-exothermic carbonation cycles at a described above temperature range in a closed loop system.

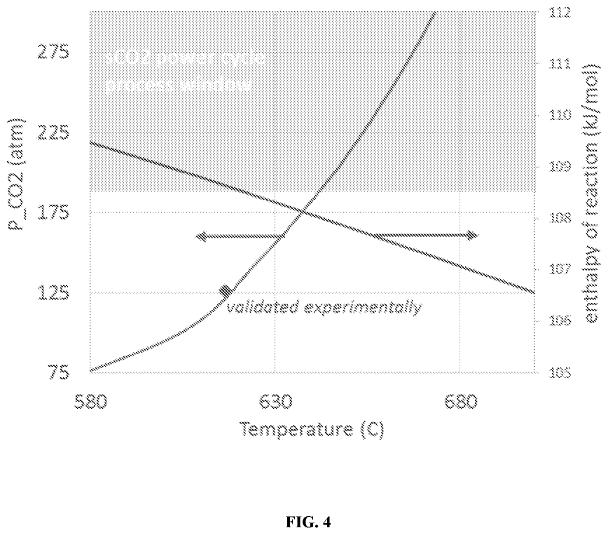

The gas-solid reaction equilibrium of MgO/MgCO₃ is shown in FIG. 4.

The solid-phase MgO and MgCO₃ reactants are contained within the reactor, for example a single pressure reactor. In the discharged state, the reactor is filled with MgCO₃ at a reduced temperature, for example, from about 450° C. to about 650° C. To charge the reactor, CO₂ is heated in part by the heat source to a temperature from about 600° C. to about 900° C., for example, from about 650° C. to about 750° C., and a portion passes through the reactor, which decomposes the MgCO₃ to MgO and CO₂. During energy discharge, the heat source can be bypassed allowing lower temperature, for example, from about 450 to less than 710° C., CO₂ to enter the reactor. The CO₂ can be present in the reactor as a gas or in a supercritical stage. A portion of this CO₂ reacts with the MgO, and releases heat, which increases the temperature of the remainder of the supercritical CO₂, which can then be expanded through a turbine to generate electricity.

It is understood that the pressure in the reactor is elevated. For example, the pressure in the reactor can be at least about 50 atm, at least about 70 atm, at least about 100 atm, at least about 150 atm, at least about 200 atm, at least about 250 atm, at least about 300 atm, or at least about 350 atm. In another example, the pressure in the reactor can be from about 50 atm to about 500 atm, such for example from about 50 atm to about 200 atm, from about 50 atm to about 100 atm, from about 200 atm to about 500 atm, from about 200 atm to about 400 atm, or from about 250 atm to about 350 atm. The pressures and temperatures disclosed herein can be combined in as desired. For example, during the discharge cycle the pressure can be from about 50 atm to about 100 atm and have a temperature from about 550° C. to about 650° C. In another example, during the charge cycle the pressure can be from about 250 atm to about 500 atm and have a temperature from about 650° C. to about 750° C.

In certain aspects, the CO₂ sorbent is a porous sorbent. In still further aspects, the pores of the sorbent can have a diameter in the range from about 1 nm to about 200 nm, for example from about 5 nm to about 200 nm, including exemplary values of about 3 nm, about 5 nm, about 8 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 120 nm, about 140 nm, about 160 nm, and about 180 nm. In yet other aspects, the sorbent comprises micropores having a diameter in the range from about 1 nm to about 10 nm, including exemplary values of about 2 nm, about 3 nm, about 4 nm, about 5 nm, about 6 nm, about 7 nm, about 8 nm, and about 9 nm. In still further aspects, the micropores can have a diameter between any two of the above stated values. In yet other aspects, the sorbent can comprise mesopores having a diameter in the range from about 10 nm to about 100 nm, including exemplary values of about 20 nm, about 30 nm, about 40 nm, about 50 nm, about 60 nm, about 70 nm, about 80 nm, and about 90 nm. In still further aspects, the sorbent can comprise macropores with a diameter greater than about 100 nm. It is understood that in some aspects, the greater pore diameter can result in a decreased total pore surface area.

In certain aspects, the CO₂ sorbent described herein have a surface area in the range from about 1 to about 1,000 m²/g, including exemplary values ranging from of about 5 to 50 m²/g.

It is further understood that the pore diameter of the sorbent can be affected by a temperature. In some aspects, at the higher reaction temperatures the sorbent can undergo sintering and form agglomerates having a higher pore size.

In certain aspects, the CO₂ sorbent can be heat treated in a non-reacting gas such as nitrogen, air, or helium prior to the use in a system at a temperature from about 600° C. to about 1,000° C., including exemplary values of about 650° C., about 700° C., about 750° C., about 800° C., about 850° C., about 900° C., and about 950° C., thereby producing a heat treated sorbent. In some aspects, the heat treatment is performed for a period of time from about 10 minutes to about 60 minutes, including exemplary values of about 20 minutes, about 30 minutes, about 40 minutes, and about 50 minutes. In yet other aspects, the sorbent is heat treated in a steam. In yet other aspects, following this heat treatment, the sorbent can be further heat treated in a gas containing about 2 to about 30 volume % CO₂ from about 600° C. to about 800° C., including exemplary values of about 650° C., about 700° C., and about 750° C. In yet other aspects, the heat treatment can be done for a time period of about 4 to about 20 hours, including exemplary values of about 6, about 8, and about 12 hours. In certain aspects, the heat treatment of the sorbent prior to the use in a system improves the sorbent durability and stability. In certain aspects, the heat treatment of the sorbent can improve a reaction rate (e.g. to increase the amount of CO₂ that can be reacted with the sorbent in a given time). In certain exemplary aspects, the absorption of CO₂ during the first reaction cycle lasting for about an can be increased from about 10 wt % to about 36 wt %, including exemplary values of about 15 wt. %, about 20 wt %, about 25 wt. %, about 30 wt. %, and about 35 wt. %, comparatively to a substantially identical sorbent that was not heat treated prior to use in a system. Without wishing to be bound by any theory, it is hypothesized that the heat treating of the sorbent prior to the use in a system can activate the sorbent by structuring the surface morphology and increasing access of the CO₂ to the pore structure.

In yet other aspects, the MgCO₃ can undergo a regeneration process at a temperature from about 450° C. to about 950° C., for example from about 550° C. to about 800° C., about 600° C. to about 800° C. including exemplary values of about 550° C., of about 600° C., about 700° C., about 750° C., about 800° C., about 850° C., and about 900° C., which is achieved with heated CO₂. This regeneration of MgCO₃ can be performed for a time period of about 30 minutes to about 12 hours, including exemplary values of about 1 hour, about 1.5 hour, about 2 hours, about 2.5 hours, about 3 hours, about 3.5 hours, about 4 hours, about 4.5 hours, about 5 hours, about 5.5 hours, about 6 hours, about 6.5 hours, about 7 hours, about 7.5 hours, about 8 hours, about 8.5 hours, about 9 hours, about 9.5 hours, about 10 hours, about 10.5 hours, about 11 hours, and about 11. 5 hours, in the presence of CO₂. In some aspects, the regeneration process can convert the magnesium carbonate (MgCO₃) back to magnesium oxide (MgO) to make it ready for the next cycle. Without wishing to be bound by any theory it is hypothesized that the regeneration process can rejuvenate the sorbent to its activated state without causing a loss in sorbent durability so that cycles can be repeated multiple times. It is further understood that the regeneration process can be conducted in the presence of CO₂.

In certain aspects, the CO₂ sorbent described herein can withstand from about 100 to about 30,000 reaction cycles without any substantial degradation, including exemplary values of about 200, about 500, about 1,000, about 1,500, about 2,000, about 2,500, about 3,000, about 3,500, about 4,000, about 4,500, about 5,500, about 6,000, about 6,500, about 7,000, about 7,500, about 8,000, about 8,500, about 9,000, about 9,500, about 10,000, about 10,500, about 11,000, about 11,500, about 12,000, about 12,500, about 13,000, about 13,500, about 14,000, about 14,500, about 15,500, about 16,000, about 16,500, about 17,000, about 17,500, about 18,000, about 18,500, about 19,000, about 19,500, about 20,000, about 20,500, about 21,000, about 21,500, about 22,000, about 22,500, about 23,000, about 23,500, about 24,000, about 24,500, about 25,500, about 26,000, about 26,500, about 27,000, about 27,500, about 28,000, about 28,500, about 29,000, and about 29,500. In yet other aspects, the CO₂ sorbent described herein can withstand any number of cycles in between any cited above values without any substantial degradation. In some aspects, the CO₂ sorbent can withstand from about 1,000 to about 20,000 cycles or from about 5,000 to about 30,000 cycles without any substantial degradation.

In certain aspects, the absence of the substantial degradation of the CO₂ sorbent can be determined by an amount of the CO₂ that can react with the CO₂ sorbent in each consequent reaction cycle conducted after the first cycle as compared to an amount of the CO₂ reacted with the CO₂ sorbent in the first cycle. In some aspects, the amount of the CO₂ reacted with the CO₂ sorbent in each consequent reaction cycle conducted after the first cycle is at least about 50% of the CO₂ reacted with the CO₂ sorbent in the first cycle, at least about 55%, at least about 60%, at least about 65%, at least about 70%, at least about 75%, at least about 80%, at least about 85%, at least about 90%, at least about 95%, at least about 99%, or at least about 99.8% of CO₂ reacted with the CO₂ sorbent in the first cycle.

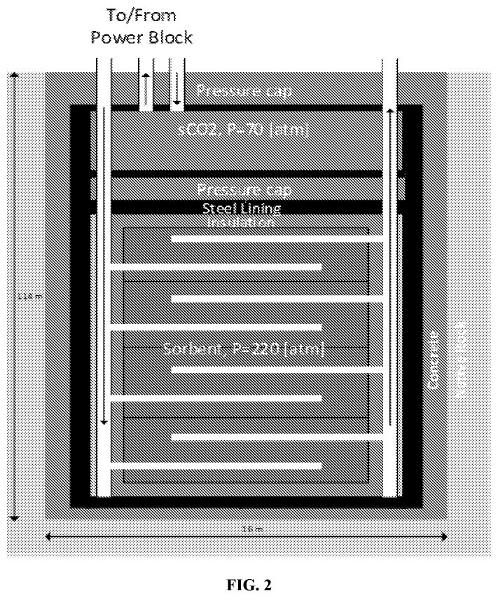

In some aspects, the reactor described herein can comprise a heat exchange reactor or an adiabatic reactor. An example of a design of a reactor disclosed herein is shown in FIG. 2. In certain aspects, the reactor is a heat exchange reactor. In other aspects, the reactor is an adiabatic reactor. It is understood that any heat exchange and adiabatic reactors known in the art can be utilized. It is further understood that the reactor can have any shape known in the art. In some aspects, the reactor is a tube. In other aspects, the reactor is a shell. In yet other aspects, the reactor is a shell and tube reactor or a fluidized-bed reactor. It is further understood that the dimensions of the reactor can be easily determined by one of ordinary skill in the art depending on the desired outcome. In some aspects, it is understood that the size of the reactor can be fitted to house a sufficient amount of CO₂ sorbent effective to react with a desired amount of CO₂. For example, an excess amount of CO₂ sorbent can be present in the reactor relative to the amount of CO₂ that is introduced into the reactor, thereby maximizing the efficiency of the CO₂ that is introduced into the reactor.

In some aspects, the system can further comprise a heat source configured to be in fluid communication with the supercritical CO₂ source and the reactor. In still further aspects, the system can further comprise a sensible heat storage unit configured to be in fluid communication with the supercritical CO₂ source and the heat source and/or reactor. In such exemplary aspects the heat storage unit can also function as the thermal insulation.

In one aspect, the containment vessel configured to be placed underground and withstand high pressure can be the supercritical CO₂ source.

In certain aspects, the heat source present in the system can comprise a solar thermal energy source. In the exemplary aspects, wherein the heat source comprises a solar thermal energy source, the solar energy can be concentrated and directed using mirrors for direct heating of the supercritical CO₂. In still further aspects, the heat source can be a waste heat pump source with a heat pump. In such exemplary aspects, in addition to the waste heat input an electrical input can be present. In yet other aspects, the heat source present in the system can increase the temperature of the supercritical CO₂ to a temperature of at least about 500° C., at least about 550° C., at least about 600° C., at least about 650° C., at least about 700° C., at least about 750° C., at least about 800° C., at least about 850° C., at least about 900° C., or at least about 950° C. For example, the heat source present in the system can increase the temperature of the supercritical CO₂ to a temperature of from about 500° C. to about 950° C., for example from about 600° C. to about 800° C. In yet other aspects, the heat source can comprise any heat source known in the art, for example and without limitation, a gas fire plant, a nuclear reactor, and the like. The supercritical CO₂ that has been heated by the heat source is then introduced into the reactor.

In another aspect, the system can further comprise a pump configured to pump supercritical CO₂ from the supercritical CO₂ source towards the heat source and/or reactor. The supercritical CO₂ that exits the supercritical CO₂ source can be compressed in a compressor and is in a dense form. Accordingly, the system can further comprise a compressor configured to be in fluid communication with the supercritical CO₂ source and the heat source and/or reactor. In yet other aspects, the system can further comprise a turbine configured to be in fluid communication with the supercritical CO₂ source and the heat source and/or reactor. In still further aspects, the system can further comprise an expander configured to be in fluid communication with the supercritical CO₂ source and the heat source and/or reactor. In still further aspects, the system can further comprise a compressor and/or a turbine and/or an expander configured to be in fluid communication with the supercritical CO₂ source and the heat source and/or reactor. It is suitable for a pump to transfer this dense supercritical CO₂ towards the heat source and/or reactor.

In another aspect, the system can further comprise one or more heat exchangers configured to be in fluid communication with the supercritical CO₂ source, the reactor, and the heat source. The supercritical CO₂ that is pumped towards the heat source and/or reactor passes through the one or more heat exchangers which has a higher temperature than the supercritical CO₂, thereby increasing the temperature of the supercritical CO₂. The temperature of the than the supercritical CO₂ can be increased by the one or more heat exchangers to a temperature from about 450° C. to about 710° C. During discharge this supercritical CO₂ having a temperature from about 450° C. to less than 710° C. is used directly to react CO₂ with MgO to produce MgCO₃ and heat. Said differently, this supercritical CO₂ having a temperature from about 450° C. to less than 710° C. is used in the reactor without being further heated by the heat source. During the charge supercritical CO₂ having a temperature from about 450° C. to less than 650° C. is further heated by the heat source before use in the reactor to drive the endothermic degradation of MgCO₃ to MgO and CO₂.

In another aspect, the system can further comprise a turbine configured to be in fluid communication with an outlet of the reactor. During the discharge cycle the CO₂, which has been heated by the exothermic reaction in the reactor, exits the reactor and is expanded in the turbine to produce electricity.

In another aspect, the system can further comprise a cooling unit configured to be in fluid communication with an outlet of the reactor and the supercritical CO₂ source. The cooling unit is used to cool CO₂ so it can be stored in the supercritical CO₂ source. The heat absorbed by the cooling unit can later be used to heat the supercritical CO₂ present in the supercritical CO₂ source to be used in the subsequent cycle.

In another aspect, the system further comprises a cooling unit configured to be in fluid communication with an outlet of the reactor, the one or more heat exchangers, and the supercritical CO₂ source. In such an aspect, the cooling unit is configured to receive CO₂ after the CO₂ has passed through the one or more heat exchangers from the outlet of the reactor.

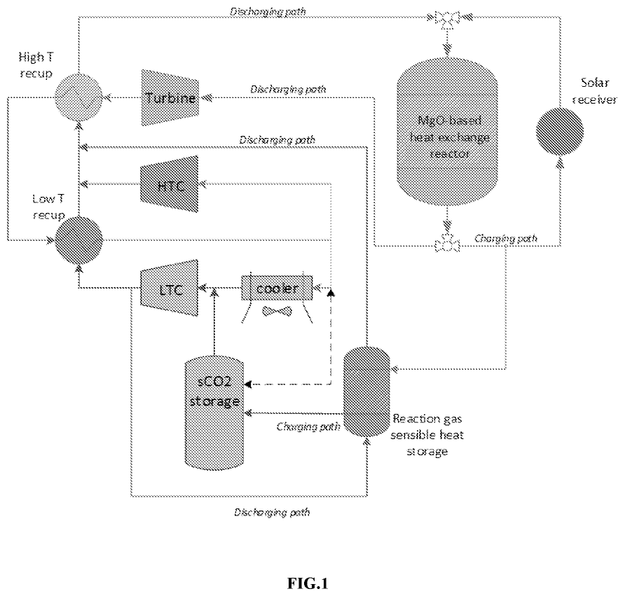

In another aspect, the system can further comprise a sensible heat storage unit configured to be in fluid communication with the supercritical CO₂ source and the heat source and/or reactor. The sensible heat storage unit is configured to receive CO₂ from a charging cycle, for example, as shown in FIG. 1. The sensible heat storage unit reduces the temperature of the CO₂ before the CO₂ is transferred to the supercritical CO₂ source for storage. The heat absorbed in the sensible heat storage unit can be used heat the supercritical CO₂ in the supercritical CO₂ source before use in the next cycle.

In another aspect, the system disclosed herein is a closed loop system.

In another aspect, the system is an industrial sized system.

Underground reactor design and methods of construction for a continuum of storage sizes ranging from 10-2000 MWh: underground excavations which exceed both our pressure and volume requirements are used commercially for gas storage of hydrocarbons. Construction methods include shaft drilling, drill & blast and solution mining. Drill & blast is preferred for the largest sizes because it is a commonly used construction technique in the US, it can be used for shaft sinking and is the most flexible as to the shape of the excavation (such as a narrow shaft at the surface, which opens into a large ellipsoid in bedrock). Our system is uniquely challenging due to the thermo-hydro-mechanical-chemical and transient considerations. Nearly all solid bedrock and grout have the compressive strength to contain the maximum system pressure of 300 atm (30 MPa), however due to multi-axial loading and the weathered condition (less weathered as depth increases) failure criteria of native rock may be exceeded. In such a case, the excavation would be surrounded by a fractured rock zone which would serve to distribute forces until stresses are reduced below the limits of what the reinforced bedrock could withstand. Our goal is to develop a universal solution of ground modification (injection grouting, chemical grouting, rock bolts, etc.) and excavation to allow these systems to be built anywhere (though costs and allowable pressure may vary). Through fracture mechanics multi-physics modeling and laboratory testing the technoeconomics will be characterized for a continuum of native earth conditions and system capacities. The highest stress region is at the top of the reactor where the bed rock overburden is thinnest and hence requires the most ground modification.

Integration of supercritical CO₂ thermochemical energy storage with supercritical CO₂ power and refrigeration cycles: assuming the supercritical CO₂ thermochemical energy storage achieves technical objectives as a stand-alone subsystem the challenge is to model and evaluate a large number of possible configurations for integration into larger systems for technoeconomics ($/W of installed capacity for cooling/heating/power, heat to power conversion efficiency, coefficient of performance, exergy efficiency, market size, and technology readiness level) to maximize commercial impact.

FIG. 1 shows an exemplary thermochemical storage energy system 100. This exemplary thermochemical storage energy system 100 is comprised of a reactor 102, a supercritical CO₂ source 104, heat source 106, one or more heat exchangers 108, a turbine 110, a cooling unit 112, a sensible heat storage unit 114, a low temperature compressor 116, and a high temperature compressor 118. The reactor 102, for example a single pressure reactor, contains a fixed bed of the CO₂ sorbent comprising MgO. Supercritical CO₂ is stored in the supercritical CO₂ source 104 at about 74 atm at about 31° C. The supercritical CO₂ is heated to about 100° C. using heat absorbed in the cooling unit 112 or the sensible heat storage unit 114 or a combination thereof. The heated supercritical CO₂ is compressed in a low temperature compressor 116 and further heated in the one or more heat exchangers 108. To discharged the reactor 102, the supercritical CO₂, which has a from about 450° C. to about 650° C., for example from about 550° C. to about 600° C., bypasses the heat source 106 and enters the reactor, for example at a pressure around 10 atm. The CO₂ can be in the form of a gas or at a supercritical state in the reactor 102. A portion of the CO₂ reacts with the MgO present in the CO₂ sorbent to form MgCO₃ and release heat, i.e. this reaction is exothermic. The heat increases the temperature of the unreacted CO₂, which is next expanded in the turbine 110, which generates electricity. The expanded unreacted CO₂ is cooled in the one or more heat exchangers 108 and the cooling unit 112 before entering the supercritical CO₂ source 104 to be stored at about 74 atm at about 31° C.

To charge the reactor 102, supercritical CO₂ is again heated to about 100° C. using heat absorbed in the cooling unit 112 or the sensible heat storage unit 114 or a combination thereof. The heated supercritical CO₂ is again compressed in a low temperature compressor 116 and further heated in the one or more heat exchangers 108. This time, the supercritical CO₂ is even further heated in the heat source 106 to a temperature from about 600° C. to about 800° C., for example, from about 650° C. to about 750° C. This heated CO₂ (supercritical or gas or combination thereof) enters the reactor 102 to decompose the MgCO₃ to MgO and CO₂. This CO₂ is separated from the sorbent and transferred of the reactor together with the heated CO₂ and is transferred to a sensible heat storage unit 114 to be cooled. The CO₂ is then further cooled in the in the one or more heat exchangers 108 and the cooling unit 112 before entering the supercritical CO₂ source 104 to be stored at about 74 atm at about 31° C.

As shown in FIG. 2 an isothermic cycle proceeds counter-clockwise in four stages 1) decarbonation of MgCO₃ to charge the system with latent heat 2) raising the temperature of the MgO-based sorbent with sensible heat 3) discharging the system of latent heat by carbonation at 675° C. 4) discharging the system of sensible heat.

It is understood that the system described herein can use in combination with the sensible heat, latent heat and any other reactions that are contained in the sorbent bed to give overall larger contributions to energy storage.

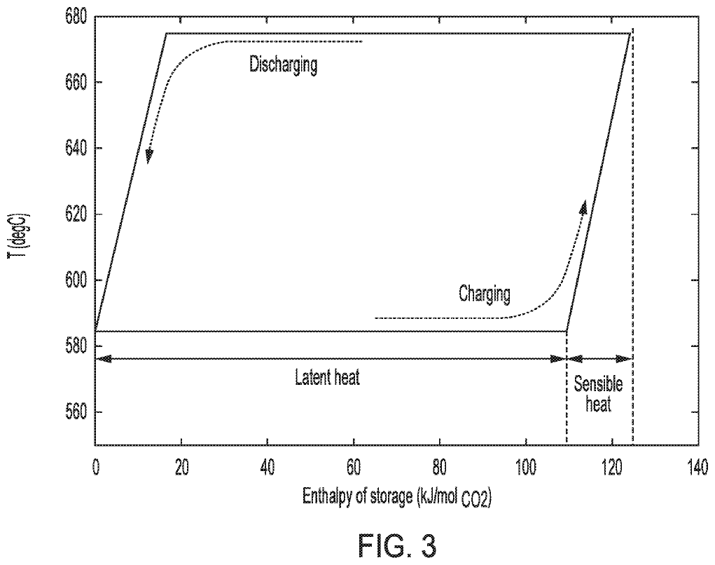

FIG. 3 shows an isothermal cycle of a system and method disclosed herein. FIG. 3 shows that the system and method disclosed here can be operated with low temperature differences, which is beneficial to the efficiency of the system.

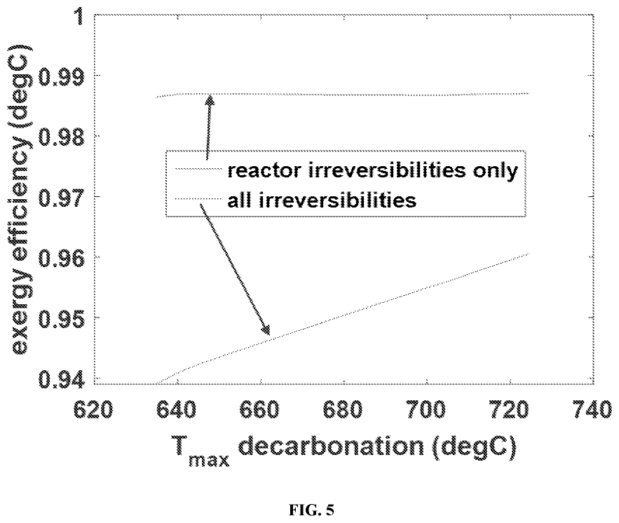

The exergy of a system disclosed herein with all irreversibles or reactor irreversibles only is shown in FIG. 5.

### 3. Methods

Disclosed herein is a method for storing energy. In some aspects disclosed herein is a method of storing energy comprising the steps of: a) in a reactor, heating and/or subjecting electrical energy to MgCO₃ or a salt of MgCO₃ with supercritical CO₂ having a temperature of at least 450° C., thereby promoting an endothermic chemical reaction to produce CO₂ and MgO; and b) separating the CO₂ from the MgO. As disclosed herein the reactor comprises a CO₂ sorbent comprising MgO.

In one aspect, the salt of MgCO₃ can be Na₂MgCO₃.

In one aspect, the method comprises heating and subjecting electrical energy and/or temperature swing, and/or pressure swing to MgCO₃ or a salt of MgCO₃ with supercritical CO₂ having a temperature of at least 450° C. It is understood that any types of electrical energy can be utilized. In some exemplary aspects, the electrical energy can comprise a resistive heating. In yet other aspects, the electrical energy can comprise a pressure swing utilizing a compressor. In still other aspects, it can comprise a temperature swing. In still further aspects, it can comprise a combination of a temperature and a pressure swing. In some exemplary aspects, the compressor can be used to lower CO₂ pressure and to decompose MgCO₃ via a pressure swing.

In another aspect, the method comprises heating and subjecting electrical energy to MgCO₃ or a salt of MgCO₃ with supercritical CO₂ having a temperature of at least 450° C.

In one aspect, the method can further comprise a step c) combining supercritical CO₂ having a temperature of less than about 710° C. with the MgO in the reactor, thereby promoting an exothermic chemical reaction to produce heat and MgCO₃. In one aspect, the produced heat can increase the temperature of unreacted supercritical CO₂ to produce heated unreacted supercritical CO₂, and wherein the heated unreacted supercritical CO₂ is expanded in a turbine to generate electricity. In yet another aspect, the expanded heated unreacted supercritical CO₂ can be cooled via one or more heat exchangers and a cooling unit before being stored in a supercritical CO₂ source.

Energy is stored as a potential future chemical reaction between CO₂ and the MgO in the CO₂ sorbent. As described elsewhere herein, the chemical reaction between CO₂ and the MgO in the CO₂ sorbent is exothermic and, energy in the form of heat is released.

In one aspect, the method can further comprise transporting at least a portion of the separated CO₂ to a supercritical CO₂ source via one or more heat exchangers and a cooling unit. The MgO in the CO₂ sorbent is, once separated and not in the presence of CO₂, available to be recombined with CO₂ to form MgCO₃.

It is understood that the reactor can comprise any reactor described herein. For example and without limitation it can comprise a heat exchange reactor, or an adiabatic reactor. In certain aspects, the CO₂ sorbent can comprise any CO₂ sorbent described herein.

In certain aspects, the method comprising steps (a) and (b) or the method comprising steps (a) through (c) of the disclosed method can be repeated for at least about 100 times, for at least about 200 times, at least about 500 times, at least about 1,000 times, at least about 1,500 times, at least about 2,000 times, at least about 2,500 times, at least about 3,000 times, at least about 3,500 times, at least about 4,000 times, at least about 4,500 times, at least about 5,500 times, at least about 6,000 times, at least about 6,500 times, at least about 7,000 times, at least about 7,500 times, at least about 8,000 times, at least about 8,500 times, at least about 9,000 times, at least about 9,500 times, at least about 10,000 times, at least about 10,500 times, at least about 11,000 times, at least about 11,500 times, at least about 12,000 times, at least about 12,500 times, at least about 13,000 times, at least about 13,500 times, at least about 14,000 times, at least about 14,500 times, at least about 15,500 times, at least about 16,000 times, at least about 16,500 times, at least about 17,000 times, at least about 17,500 times, at least about 18,000 times, at least about 18,500 times, at least about 19,000 times, at least about 19,500 times, at least about 20,000 times, at least about 20,500 times, at least about 21,000 times, at least about 21,500 times, at least about 22,000 times, at least about 22,500 times, at least about 23,000 times, at least about 23,500 times, at least about 24,000 times, at least about 24,500 times, at least about 25,500 times, at least about 26,000 times, at least about 26,500 times, at least about 27,000 times, at least about 27,500 times, at least about 28,000 times, at least about 28,500 times, at least about 29,000 times, at least about 29,500 times, or at least about 30,000 times.

In yet other aspects, the method comprising steps (a) through (c) can be repeated at least 1,000 time, wherein the amount of CO₂ can be reacted with the CO₂ sorbent in step c) throughout the method is at least 50% of the amount of CO₂ that could be reacted with the CO₂ sorbent prior to performing the method. In some aspects, the amount of CO₂ that could be reacted with the CO₂ sorbent is at least about 50%, at least about 55%, at least about 60%, at least about 65%, at least about 70%, at least about 75%, at least about 80%, at least about 85%, at least about 90%, at least about 95%, or at least about 99% of the amount of CO₂ that could be reacted with the CO₂ sorbent prior to performing the method.

In yet other exemplary aspects, the CO₂ capacity does not decrease by more than 50%, more than 40%, more than 30%, more than 20%, more than 10%, more than 5%, or more than 1% after 1,000 cycles.

In certain aspects, the steps (a) through (c) can be repeated from 1,000 to 20,000 times, wherein the amount of CO₂ that can be reacted with the CO₂ sorbent in step c) throughout the method is at least 50% of the amount of CO₂ that could be reacted with the CO₂ sorbent prior to performing the method. In some aspects, the amount of CO₂ that could be reacted with the CO₂ sorbent is at least about 50%, at least about 55%, at least about 60%, at least about 65%, at least about 70%, at least about 75%, at least about 80%, at least about 85%, at least about 90%, at least about 95%, or at least about 99% of the amount of CO₂ that could be reacted with the CO₂ sorbent prior to performing the method.

In yet other exemplary aspects, the CO₂ capacity does not decrease by more than 50%, more than 40%, more than 30%, more than 20%, more than 10%, more than 5%, or more than 1% after 1,000 to 20,000 cycles.

### Aspects

In view of the described systems and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A system for storing energy comprising: a) a reactor comprising a CO₂ sorbent comprising MgO; and b) a supercritical CO₂ source, wherein the supercritical CO₂ source is in fluid communication with the reactor and the CO₂ sorbent comprising MgO to allow flow of supercritical CO₂ between the supercritical CO₂ source and the reactor, thereby allowing contact of CO₂ with the CO₂ sorbent comprising MgO.

Aspect 2: The system of aspect 1, wherein the system further comprises a heat source configured to be in fluid communication with the supercritical CO₂ source and the reactor.

Aspect 3: The system of aspect 2, wherein the system further comprises a pump configured to pump supercritical CO₂ from the supercritical CO₂ source towards the heat source and/or reactor.

Aspect 4: The system of aspect 3, wherein the system further comprises one or more heat exchangers configured to be in fluid communication with the supercritical CO₂ source, the reactor, and the heat source.

Aspect 5: The system of any one of aspects 1-4, wherein the system further comprises a turbine configured to be in fluid communication with an outlet of the reactor.

Aspect 6: The system of any one of aspects 1-5, wherein the system further comprises a compressor, and/or a turbine, and/or an expander configured to be in fluid communication with the supercritical CO₂ source and the heat source and/or reactor.

Aspect 7: The system of any one of aspects 1-6, wherein the system further comprises a cooling unit configured to be in fluid communication with an outlet of the reactor and the supercritical CO₂ source.

Aspect 8: The system of any one of aspects 3-7, wherein the system further comprises a cooling unit configured to be in fluid communication with an outlet of the reactor, the one or more heat exchangers, and the supercritical CO₂ source.

Aspect 9: The system of any one of aspects 1-8, wherein the system further comprises a sensible heat storage unit configured to be in fluid communication with the supercritical CO₂ source and the heat source and/or reactor.

Aspect 10: The system of any one of aspects 1-9, wherein the reactor is a heat exchange reactor.

Aspect 11: The system of any one of aspects 1-10, wherein the heat source is a solar thermal energy and/or a waste heat pump source.

Aspect 12: The system of any one of aspects 1-11, wherein the system is a closed loop system.

Aspect 13: The system of one of aspects 1-12, wherein the supercritical CO₂ source is the containment vessel of any one of aspects 27-34.

Aspect 14: A method of storing energy comprising the steps of: a) in a reactor, heating and/or subjecting electrical energy to MgCO₃ or a salt of MgCO₃ with supercritical CO₂ having a temperature of at least 450° C., thereby promoting an endothermic chemical reaction to produce CO₂ and MgO; and b) separating the CO₂ from the MgO.

Aspect 15: The method of aspect 43, wherein the method further comprises transporting at least a portion of the separated CO₂ to a supercritical CO₂ source via one or more heat exchangers and a cooling unit.

Aspect 16: The method of aspects 14 or 15, wherein the method further comprises step c) combining supercritical CO₂ having a temperature of less than about 710° C. with the MgO in the reactor, thereby promoting an exothermic chemical reaction to produce heat and MgCO₃.

Aspect 17: The method of aspect 16, wherein the heat increases the temperature of unreacted supercritical CO₂ to produce heated unreacted supercritical CO₂, and wherein the heated unreacted supercritical CO₂ is expanded in a turbine to generate electricity.

Aspect 18: The method of aspect 17, wherein the expanded heated unreacted supercritical CO₂ is cooled via one or more heat exchangers and a cooling unit before being stored in a supercritical CO₂ source.

Aspect 19: The method of aspect 18, wherein the method further comprises, prior to step a), increasing the temperature of the supercritical CO₂ in a supercritical CO₂ source by transferring heat from the cooling unit and/or a latent heat storage unit to the supercritical CO₂ source.

Aspect 20: The method of any one of aspects 16-19, wherein steps a)-c) are repeated at least 1,000 times, wherein the amount of CO₂ that can be reacted with the MgO in step c) throughout the method is at least 50% of the amount of CO₂ that could be reacted with the MgO prior to performing the method.

Aspect 21: The method of any one of aspects 16-19, wherein steps a)-c) are repeated from 1,000 to 20,000 times, wherein the amount of CO₂ that can be reacted with the MgO in step c) throughout the method is at least 50% of the amount of CO₂ that could be reacted with the MgO prior to performing the method.

Aspect 22: The method of any one of aspects 14-21, wherein the method comprises heating and electrical energy and/or temperature swing and/or pressure swing to MgCO₃ or a salt of MgCO₃ with supercritical CO₂ having a temperature of at least 450° C.

Aspect 23: The method of any one of aspects 14-21, wherein the method comprises heating and subjecting electrical energy to MgCO₃ or a salt of MgCO₃ with supercritical CO₂ having a temperature of at least 450° C.

Aspect 24: The method of any one of aspects 14-23, wherein MgCO₃ is used in the method.

Aspect 25: The method of any one of aspects 14-23, wherein a salt of MgCO₃ is used in the method.

Aspect 26: The method of any one of claims 14-25, wherein the supercritical CO₂ source is the containment vessel of any one of claims 27-34.

Aspect 27: A containment vessel configured to be placed underground and withstand high pressure comprising: a) a metal housing configured to sustain temperatures of at least 300° C. at a pressure of at least 200 atm during use; i. wherein the metal housing is at least partially surrounded by an inflatable liner configured to be inflated and to be filled with a filler; and ii. wherein the housing comprises an opening configured to transfer material to and from the metal housing.

Aspect 28: The containment vessel of aspect 27, wherein a filler is present between the liner and the metal housing.

Aspect 29: The containment vessel of aspect 28, wherein the filler comprises grout.

Aspect 30: The containment vessel of aspect 27, wherein the liner is inflated.

Aspect 31: The containment vessel of any of aspects 27-30, wherein containment vessel is under ground.

Aspect 32: The containment vessel of aspect 31, wherein the containment vessel is at least partially surrounded by bedrock.

Aspect 33: The containment vessel of any of aspects 27-32, wherein the metal housing has a diameter from about 4 meters to about 15 meters.

Aspect 34: The containment vessel of any of aspects 27-33, wherein the metal housing has a height from about 10 meters to about 100 meters.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

A MgO sorbent was synthesized. No promoter was added to the MgO sorben. As a screening before testing the sorbent was held in a furnace at 650° C. in air (decarbonated state) and the surface area was measured at 16, 32, and 80 hr to be 49.86, 49.76 and 50.36 m²/g, respectively. The surface area of this MgO sorbent is stable at 10× the magnitude of a comparable CaO sorbent, which has recently demonstrated no long-term degradation under 600 accelerated cycles in the thermo gravimetric analysis (TGA). The stability is not unexpected because the melting temperature of MgO is 239° C. higher than CaO, which results in a lower homologous temperature T_{H}=T/Tₘₑₗₜ and less mass diffusion and sintering. The tapped density was measured to be 834 kg/m³. The system was commissioned and the experiment ran for 2 days. Leaks at the high temperature seals limited the time between recharges to ˜8 hrs. The system design, instrumentation, operation and sensitivity of the analysis method were all proven successful. The sorbent performance can be summarized by a single observed decarbonation half cycle beginning at 126 atm and 615.8° C. The sorbent released 4.31 g of CO₂ over 29.5 min which equates to a CO₂ weight gain of 26.9%. This is a lower bound estimate if the simultaneous system leak rate was accounted for, this mass of CO₂ released would be higher.

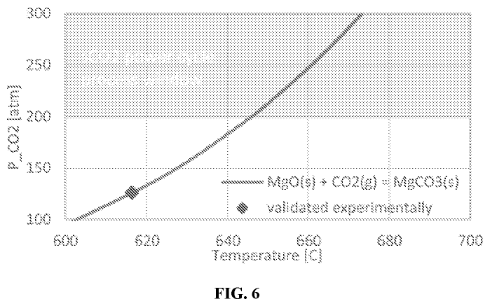

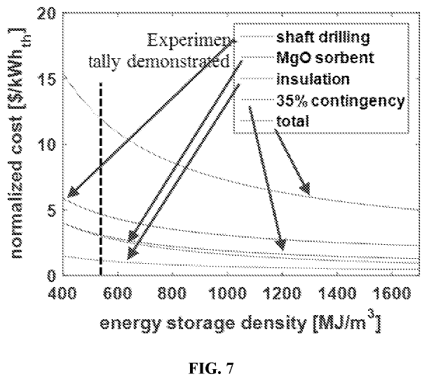

The following conclusions can be drawn: 1) the equilibrium curve predicted by thermochemical modeling is verified (FIG. 6), 2) the reaction kinetics are fast enough that a promoter may not be necessary 3) the overall energy capacity equates to 547 MJ/m³ which is within TEA targets (FIG. 7), 4) the low-cost manufacturing method is suitable for this application. Although the long-term durability of the sorbent has not been characterized, there are still many parameters to optimize for increased performance, including the addition of promoters.

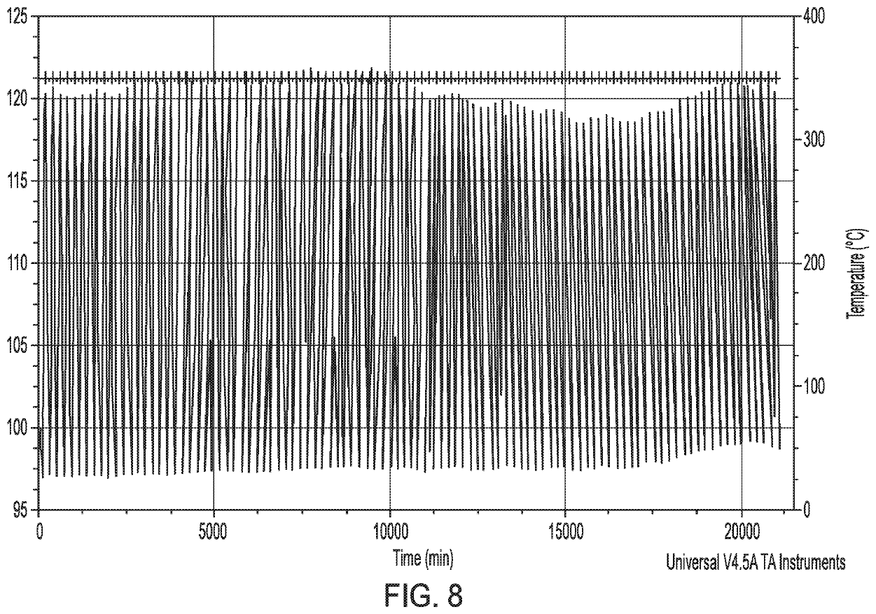

It was also demonstrated a stable weight gain of 25% for the MgO-based sorbent at 350° C. (FIG. 8).

1. A system for storing energy comprising:
a) a reactor comprising a CO₂ sorbent comprising MgO; and
b) a supercritical CO₂ source, wherein the supercritical CO₂ source is in fluid communication with the reactor and the CO₂ sorbent comprising MgO to allow flow of supercritical CO₂ between the supercritical CO₂ source and the reactor, thereby allowing contact of CO₂ with the CO₂ sorbent comprising MgO.

2. The system of claim 1, wherein the system further comprises a heat source configured to be in fluid communication with the supercritical CO₂ source and the reactor.

3. The system of claim 2, wherein the system further comprises a pump configured to pump supercritical CO₂ from the supercritical CO₂ source towards the heat source and/or reactor.

4. The system of claim 3, wherein the system further comprises one or more heat exchangers configured to be in fluid communication with the supercritical CO₂ source, the reactor, and the heat source.

5. The system of claim 1, wherein the system further comprises a turbine configured to be in fluid communication with an outlet of the reactor.

6. The system of claim 1, wherein the system further comprises a compressor, and/or a turbine, and/or an expander configured to be in fluid communication with the supercritical CO₂ source and the heat source and/or reactor.

7. The system of claim 1, wherein the system further comprises a cooling unit configured to be in fluid communication with an outlet of the reactor and the supercritical CO₂ source.

8. The system of claim 3, wherein the system further comprises a cooling unit configured to be in fluid communication with an outlet of the reactor, the one or more heat exchangers, and the supercritical CO₂ source.

9. The system of claim 1, wherein the system further comprises a sensible heat storage unit configured to be in fluid communication with the supercritical CO₂ source and the heat source and/or reactor.

10. The system of claim 1, wherein the reactor is a heat exchange reactor.

11. The system of claim 1, wherein the heat source is a solar thermal energy and/or a waste heat pump source.

12. The system of claim 1, wherein the system is a closed loop system.

13. The system of claim 1, wherein the supercritical CO₂ source is a containment vessel configured to be placed underground and withstand high pressure comprising:
a) a metal housing configured to sustain temperatures of at least 300° C. at a pressure of at least 200 atm during use;
i) wherein the metal housing is at least partially surrounded by an inflatable liner configured to be inflated and to be filled with a filler; and
ii) wherein the housing comprises an opening configured to transfer material to and from the metal housing.

14. A method of storing energy comprising the steps of:
a) in a reactor, heating and/or subjecting electrical energy to MgCO₃ or a salt of MgCO₃ with supercritical CO₂ having a temperature of at least 450° C., thereby promoting an endothermic chemical reaction to produce CO₂ and MgO; and
b) separating the CO₂ from the MgO.

15. The method of claim 14, wherein the method further comprises transporting at least a portion of the separated CO₂ to a supercritical CO₂ source via one or more heat exchangers and a cooling unit.

16. The method of claim 14, wherein the method further comprises step c) combining supercritical CO₂ having a temperature of less than about 710° C. with the MgO in the reactor, thereby promoting an exothermic chemical reaction to produce heat and MgCO₃.

17. The method of claim 16, wherein the heat increases the temperature of unreacted supercritical CO₂ to produce heated unreacted supercritical CO₂, and wherein the heated unreacted supercritical CO₂ is expanded in a turbine to generate electricity.

18. (canceled)

19. (canceled)

20. The method of claim 16, wherein steps a)-c) are repeated at least 1,000 times, wherein the amount of CO₂ that can be reacted with the MgO in step c) throughout the method is at least 50% of the amount of CO₂ that could be reacted with the MgO prior to performing the method.

21. (canceled)

22. The method of claim 14, wherein the method comprises heating and subjecting electrical energy and/or temperature swing and/or pressure swing to MgCO₃ or a salt of MgCO₃ with supercritical CO₂ having a temperature of at least 450° C.

23. (canceled)

24. (canceled)

25. (canceled)

26. (canceled)

27. A containment vessel configured to be placed underground and withstand high pressure comprising:
a) a metal housing configured to sustain temperatures of at least 300° C. at a pressure of at least 200 atm during use;
i. wherein the metal housing is at least partially surrounded by an inflatable liner configured to be inflated and to be filled with a filler; and
ii. wherein the housing comprises an opening configured to transfer material to and from the metal housing.

28.-34. (canceled)
